(19) United States
(12) Patent Application Publication
(10) Pub. No.: US 2009/0030792 A1
(43) Pub. Date: Jan. 29, 2009

(54) CONTENT RECOMMENDATION SERVICE

(76) Inventors: Amit Khivesara, Clifton, NJ (US); Yiu Man Leung, Franklin Township, NJ (US); Cary Torkelson, Allendale, NJ (US); Vinod Valloppillil, San Francisco, CA (US); Edgar Villanueva, Rockaway, NJ (US)

Correspondence Address: Hanify & King Professional Corporation, 1875 K STREET, SUITE 707, WASINGTON, DC, 20006, US

(21) Appl. No.: 12/176,794

(22) Filed: Jul. 21, 2008

Related U.S. Application Data
(60) Provisional application No. 60/935,042, filed on Jul. 24, 2007.

(51) Int. Cl. G06Q 30/00

(52) U.S. Cl. 705/14

(57) ABSTRACT

A method and system for content recommendation make such recommendations possible, even if users are in different geographic locations, use different network service providers and different services, user different types of device, etc. A method for communicating a content recommendation comprises receiving a recommendation for content, the content recommendation originating from a first client device communicating using a first network and destined for a second client device communicating using a second network, determining access information for the second client device to access the content using the second network, and transmitting the determined access information.

### CROSS-REFERENCE TO RELATED APPLICATIONS

This application claims the benefit of Provisional Application No. 60/935,042, filed Jul. 24, 2007, the contents of which are incorporated herein in their entirety.

### BACKGROUND OF THE INVENTION

1. Field of the Invention

The present invention relates to a method and system by which a person viewing, listening to, or otherwise browsing programming or other content can recommend that programming or other content to another user who may or may not be on the same network, or may or may not have similar access to the programming or other content by being able to uniquely identify the content being recommended and determining how to describe and access that same content for both users even if they access the content using different means.

2. Description of the Related Art

It is likely that users of any content provided by a content provider will want to recommend content they are viewing to other people, such as their friends. The content delivery method could be via a mobile phone network, Cable television network, satellite network, IP network, off-the-air broadcast, etc. For example, user A may be watching a Mobile TV program or on-demand video. If user A enjoys the content, user A may want to recommend that user B watch the program as well. There are several potential problems that might make it difficult or impossible for that recommendation to happen, such as:
User A and user B might have separate channel lineups.
User A and user B might be in different time zones.
User A and user B might have different Electronic Service Guide (ESG) language preferences.
User A might be using different types of devices. For example, user A might be using a CBMS device, while user B is using an OMA-BCAST device.
For user A, the program might be available only on unicast, for user B, it might be available on a broadcast channel
For user A, the program might be free while for user B it's a pay-per-view
For user A, the program might be available at one URL, while for user B it's available on a system with a different URL and content ID scheme

Unless user A and user B are in the same geographic location, use the same client device, use the same communication network, and subscribe to the same services from the same content provider, program recommendations can prove difficult if not impossible.

A need arises for a technique to make such recommendations possible, even if users are in different geographic locations, use different communication networks, use different content providers and different services, use different types of device, etc.

### SUMMARY OF THE INVENTION

A method and system for content recommendation makes such recommendations possible, even if users are in different geographic locations, use different content providers and different services, use different types of device, etc. The person-to-person content recommendation system includes a content provider content recommendation module located in each content provider system, a content recommendation server that handles the conversion, if necessary, of how specific content is accessed on different content providers, and a client content recommendation module located on each device to allow users to make and receive recommendations. The content recommendation server has access to global content and programming information, including how to access that content for each content provider's content delivery system. The client recommendation module may be integrated with the electronic service guide (ESG), since users will most likely make or view program recommendations while browsing content with the ESG.

A method for communicating a content recommendation comprises receiving an original recommendation for content, the content recommendation originating from a first client device communicating using a first communication network and first content delivery system and destined for a second client device communicating using the first communication network or a second communication network, determining the updated recommendation for the second client device to access the content using the second content delivery system, and providing the determined access information directly or indirectly to the second client device.

The content may be broadcasted content, simulcast content, file based content, or on-demand streaming content. The access information depends on the content delivery system, may include but not limited to at least one of channel identifier, Uniform Resource Locator, content ID, file name, multicast SDP. The updated recommendation may comprise at least one of a description of the content, at least one access method to use to access the content, and at least one time at which to access the content.

In the following description of the present invention, the first content delivery system may deliver content via the first communication network, or via a separate delivery mechanism. The second content delivery system may deliver content via the first or second communication network, or via a separate delivery mechanism. The first and second communication networks may be the same network. The first and second content delivery systems may be the same system.

An optional content recommendation module located in each content provider system comprises program instructions executable by a processor located in the content provider' network to perform steps of receiving a original recommendation for content from the first client device via the first network service provider's network, determining the updated recommendation for the second client device if the second device is on the same network, requesting updated recommendation for the second client device from the content recommendation server, receiving the updated recommendation from the content recommendation server, receiving the updated recommendation transmitted from another network service provider, transmitting the updated recommendation to the first client device, or optionally transmitting the updated recommendation to the second network service provider. If the optional content recommendation module is omitted in the implementation, the user client device can communicate directly to the content recommendation server via a communication network for determination of the updated recommendation.

A content recommendation server system for determining content recommendations comprises a processor to execute computer program instructions, a memory to store access information for a plurality content on a plurality of network service provider networks, and computer program instructions executable by the processor to perform the steps of receiving an original recommendation for content destined for a second client device communicating using a second network service provider network from a content recommendation module located at the first content provider system, determining the updated recommendation for the second client device to access the content, and transmitting the updated recommendation to the content recommendation module located at the first content provider system or the second content provider system.

A client device for providing content recommendation services to the user of the client device comprises a processor to execute computer program instructions, communication circuitry to communicate information using a communication network, and a memory to store computer program instructions executable by the processor. The client device may perform as a recommendation originator or a recommendation receiver at any time. As a recommendation originator the computer programs performs one or more of the following functions: originating a recommendation upon request of the user; transmitting the original recommendation to another client device communicating using the same or a different communication network, to the content recommendation module located in a content provider system, or a content recommendation server via a communication network; receiving the updated recommendation from the content recommendation module located in a content provider system or a content recommendation server via a communication network; transmitting the updated recommendation to another client device communicating using the same or a different communication network, As a recommendation receiver, the computer program performs one or more of the following functions: receiving an original recommendation for content originating from another client device communicating using another the same or different communication network; transmitting the original recommendation to the content recommendation module located in a content provider system or a content recommendation server via a communication network; receiving the updated recommendation from another client device, the content recommendation module located in a content provider system, or a content recommendation server via a communication network; notifying the user that a content recommendation is available; displaying the received updated content recommendation to the user; accessing the content via one of the access methods included in the updated recommendation, rendering or otherwise processing the acquired content.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary diagram of a system in which the present invention may be implemented.

FIG. 2 is an exemplary flow diagram of a process of delivering a recommendation that may be performed in the system shown in FIG. 1

FIG. 3 is an exemplary diagram illustrating an example where a recommendation is given by a user on one network and delivered to a user on a different network.

FIG. 4 is an exemplary diagram illustrating ESG browser integration.

FIG. 5 is an exemplary diagram illustrating how users may view recommendations they have received.

FIG. 6 is an exemplary flow diagram of a process to recommend content using an alternative recommendation flow.

FIG. 7 illustrates data flow during the process shown in FIG. 6.

FIG. 8 illustrates an example of a process to recommend content using the alternative recommendation flow.

FIG. 9 illustrates data flow during the process shown in FIG. 8.

FIG. 10 illustrates data flow in a system in which program access information is maintained by a third-party ESG provider.

FIG. 11 is an exemplary block diagram of a server computer system in which the present invention may be implemented.

FIG. 12 is an exemplary block diagram of a client device in which the present invention may be implemented.

### DETAILED DESCRIPTION OF THE INVENTION

The person-to-person content recommendation system includes a content recommendation module located in each content provider system, a content recommendation server that handles the conversion, if necessary, of how specific content is accessed on different content providers' content delivery systems, and a client content recommendation module located on each device to allow users to make and receive recommendations. The content recommendation server has access to global content and programming information, including how to access that content for each content provider. The client module may be integrated with the electronic service guide (ESG), since users will most likely make or view program recommendations while browsing content with the ESG. It is possible that the network service provider also be the content provider.

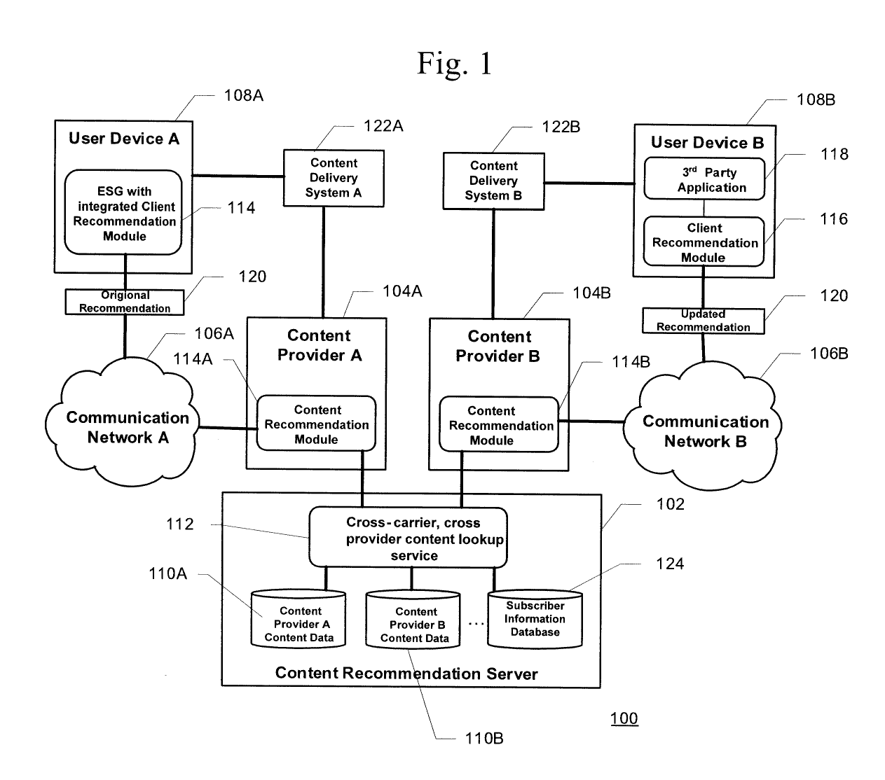

An exemplary system 100 in which the present invention may be implemented is shown in FIG. 1. System 100 includes content recommendation server 102, a plurality of content provider systems, such as systems 104A-B, communicatively connected to content recommendation server 102, a plurality of communications networks, such as network service provider's networks 106A-B, communicatively connecting content provider system 104A-B, and a plurality of user devices, such as devices 108A-B, communicatively connected by network service provider's networks 106A-B. Content Recommendation Server 102 includes content data 110A-B for each of the content provider systems 104A-B, a subscriber information database 124, and software that provides a cross-carrier, cross-provider content lookup service 112. The information in the subscriber information database may include, but is not limited to subscriber identification, location of the subscriber, identification of the network service provider to which the user's client device is connected, user's client device's communication capability, user's client device's display capability. Information in the subscriber information database 124 may be supplied by the network service providers. Users can also supply information to the subscriber information database through a registration mechanism. The content recommendation server provides functions such as:
Receives requests to recommend content to another user, and notifies the service provider system of that other user that a recommendation has been made, providing content details specific to the content provider system receiving the recommendation
If global content identifiers are not used by a content provider, translates between the content identifiers used by the content provider and the corresponding global content identifier
Aggregates and manages content access methods and times for each network service provider and content provider supported

Content provider systems 104A-B each includes a content recommendation module, such as modules 114A-B. The content recommendation module provides functions such as:
Receives requests from users on the network to recommend content to other users on the same or another network
Distributes recommendations from other users to a user on the network
Notifies the content recommendation server of a recommendation made by a user served by the content provider system
Receives recommendations from the content recommendation server for users served by the content provider system
Handles client requests to identify specific content given a global content identifier
For recommendations between users on the same network, performs any needed translations for content access times and/or methods

Each content provider may have their own content delivery system 122A-B. Methods of delivery may comprise but not limited to broadcast, simulcast, over-the-air, point-to-point using standard bearer network such as MediaFLO™, DVB-H, DMB, MBMS, BCMCS, GSM, GPRS, EVDO, WiMAX, LTE, Wi-Fi, CDMA, etc., or a private or proprietary bearer network. The bearer network for the content delivery to a client device may or may not be the same as the communication network used by the client device.

Communication networks 106A-B provide communications between user devices, such as devices 108A-B and content provider systems, such as 104A-B. In the example shown in FIG. 1, user device 108A includes an ESG with an integrated client recommendation module, while user device 108B includes a client recommendation module 116 that works in conjunction with a third-party application 118. These are merely examples of arrangements of functionality, the present invention contemplates these and other arrangements. The client recommendation module, whether standalone, or integrated, provides functions such as:
Gives applications on the device the ability to allow users to recommend content to another person.
Provides a common application interface to applications on the device to forward content recommendations to the recommendation module sitting in the content provider system.
Receives recommendations that originate from other users on the same and other network service provider networks and makes those recommendations available to applications on the device.

Typically, a recommendation 120 is transmitted from a user device, such as device 108A, communicated via network 106A to a content provider system 104A, communicated to content recommendation server 102, communicated to content provider system 104B, and communicated via network 106B to another user device, such as device 108B. This flow is described in more detail below.

The content recommendation server needs to have ESG data for all content that can be recommended from one user to another. This ESG data must include details on how, and when, if the content is not available on-demand, to access the content being recommended for each content provider supported. It may also be the case where different users on the same network service provider access the content differently. For example, users in different time zones may access the same program at a different local time even if they are using the same network service provider. Enough data must also be available to match corresponding content between users, be they on the same network service provider or a different network service provider.

An electronic service guide (ESG) refers to the data and application used to present data to a user that contains a listing of services, programs, or other content that the user can access. The data includes not only programming information such as time, title, and details, but how the application tunes in to or otherwise accesses the content. The content need not be time based, such as a video on demand channel. Traditional ESGs provide the user details on programs, services, and other content available from a single provider. A unified ESG combines ESG data from multiple providers and presents the combined data using a single application to the user.

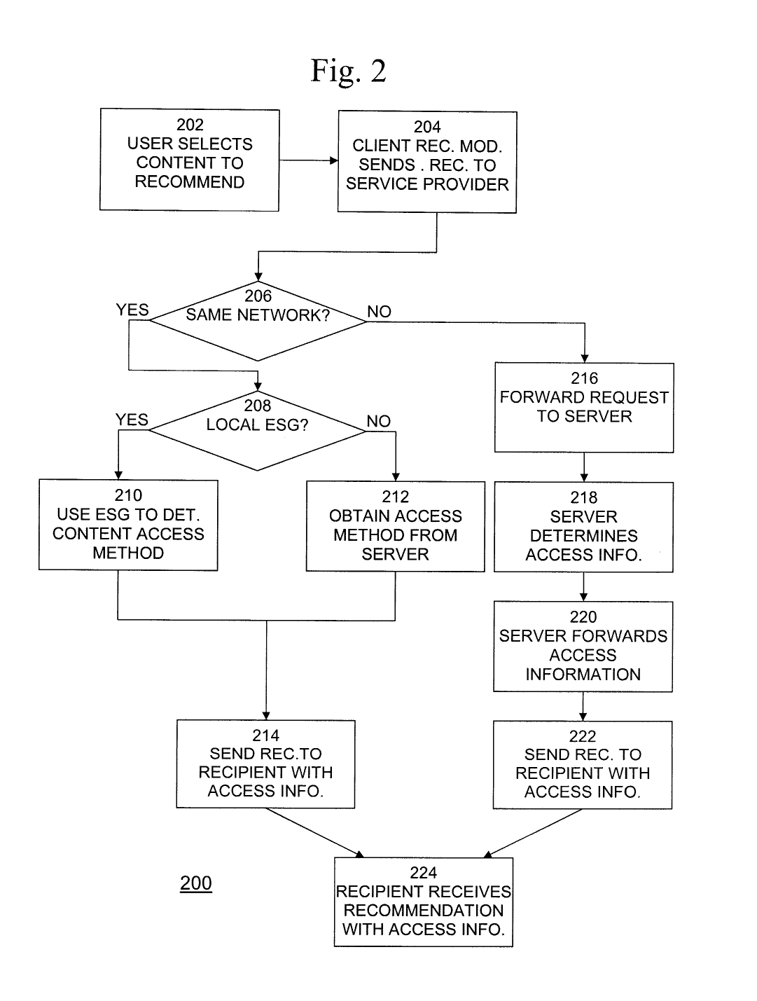

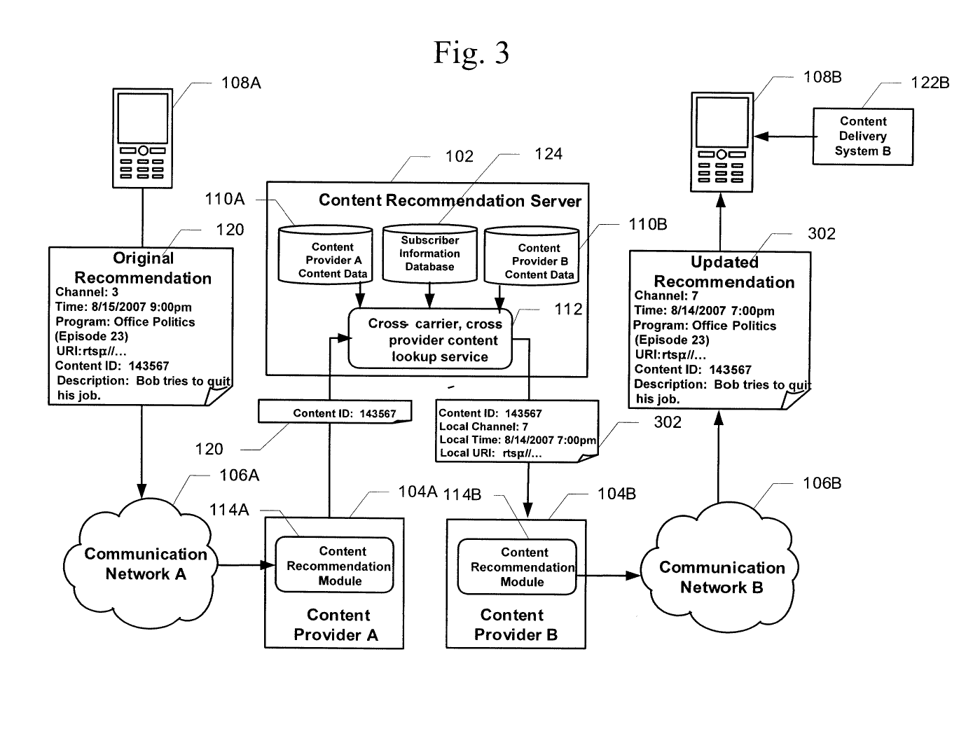

A cross carrier content recommendation service allows users to recommend programming content to other users even in situations where the updated recommended content is accessed at a different time, or via a different access method than the user making the recommendation. The updated recommendation may comprise at least one of a description of the content, at least one access method to use to access the content, and at least one time at which to access the content. FIG. 2 is a flow diagram of a process of delivering a recommendation. It is best viewed in conjunction with FIG. 3, which is an exemplary flow of a recommendation through the system shown in FIG. 1. FIG. 3 illustrates an example where a recommendation is given by a user on one network and delivered to a user on a different network.

Process 200 begins with step 202, in which a user using a client device 108A on one network service provider's network 106A selects a piece of content to recommend to another user using either the ESG with the recommendation module built-in, or via a third-party application that uses the client recommendation module. In step 204, the client recommendation module sends the original recommendation 120 from the user's device 108A to the content recommendation module 114A located in the network service provider's network.

In step 206, it is determined whether the recommendation is destined for a user on the same network service provider network 104A. If so, then in step 208, it is determined whether local ESG data is available at the network service provider network 104A. If so, then in step 210, the recommendation module 114A determines the updated recommendation information for the recipient using the local ESG data. If, in step 208, it is determined that local ESG data is not available, then in step 212, the recommendation module obtains the updated recommendation 302 from the content recommendation server 102.

In step 214, recommendation module 114A sends the recommendation 302 with the recipient's time and access information obtained in step 210 or 212 to the recipient via network 104A, whereas in this case the destined user is on the same network.

If, in step 206, it is determined that the recommendation is destined for a user on another network service provider network 106B, then in step 216, the recommendation module 114A forwards the request 120 to the content recommendation server 102. In step 218, the recommendation server 102 determines the updated recommendation 302 for the recipient on the other network service provider's network 104B. In step 220, the recommendation server 102 forwards the updated recommendation 302 obtained above to the recommendation module 114B on the recipient's network service provider's network 106B. In step 222, the recommendation module 114B on the recipient's network service provider's network 104B sends the updated recommendation information 302 to the recipient's device 108B. Alternatively, in step 222, the updated recommendation 302 can be sent back to the recommendation module 114A which in turn sends the updated recommendation 302 to the recommendation module 114B on the recipient's network service provider's network 104B. The recommendation module 114B on the recipient's network service provider's network 104B then sends the updated recommendation information 302 to the recipient's device 108B.

In both cases above, in step 224, the recipient's client recommendation module 116 receives the updated recommendation and informs any registered third-party application 118 of the updated recommendation, or the ESG directly if the ESG browser has the client recommendation module built-in. Depending on the nature of the application, the updated recommendation may be displayed to the user immediately, or at a later time. The user and/or application may use the access information in the updated recommendation to view, download, or record the content at appropriate time, making use of the content delivery system 122B.

The preferred user client device as described in this invention is a mobile phone or similar mobile device. However, the devices contemplated by the present invention include any device capable of both communications and content display and/or playback. For example such a device could be a Set Top Box, which can display the content information of an attached television set. A Set Top Box could have a back channel to communication with the content provider's recommendation module. This communication channel can also be used to communicate with another user's client device using variable methods. The method of communication is outside the scope of this invention.

Client Recommendation Module

The client recommendation module is responsible for sending the original recommendations to, and receiving updated recommendations from the corresponding content provider content recommendation module. The client recommendation module provides an API so that applications on the device can make content recommendations. It is also responsible for notifying registered applications on the device that a recommendation has been received.

ESG Browser Integration

The client recommendation module may be integrated directly with the ESG browser application to make it easy for users to recommend content to other users. Since users will use the ESG browser to find and view all the content they have access to, recommending content from the ESG browser would provide the simplest means to make such recommendations.

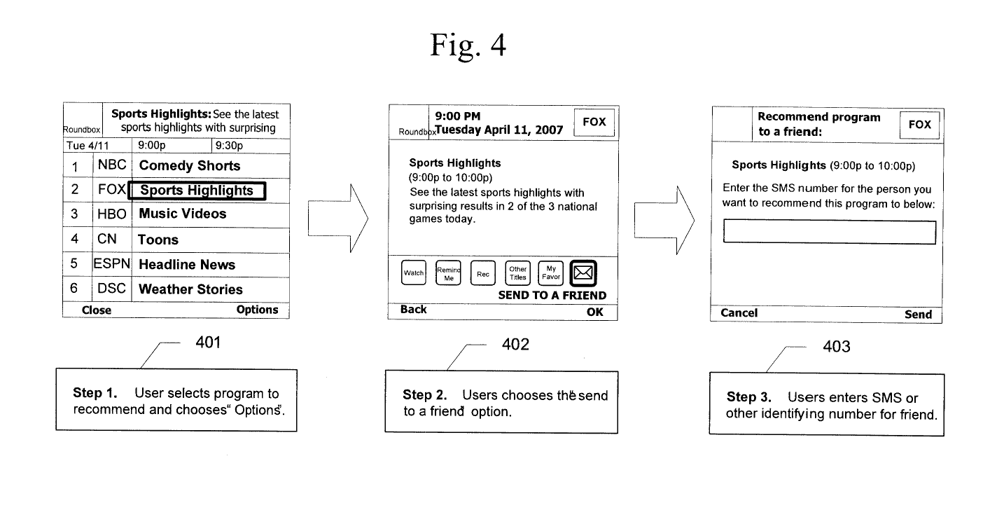

As shown in FIG. 4, in step 401, the user would locate a program or other content they wish to recommend to another user. Once selected, in step 402, the user would choose the options menu and select option labeled as “send to a friend”, or other similar label, to recommend the selected program to another user. In step 403, the user would then enter the SMS number, or other contact information for the person they wish to recommend the program to. The ESG browser may support linking to an address book or other storage area where a list of people the user previously entered can be used so as to avoid needing to re-enter the SMS number or other contact information every time a recommendation is made.

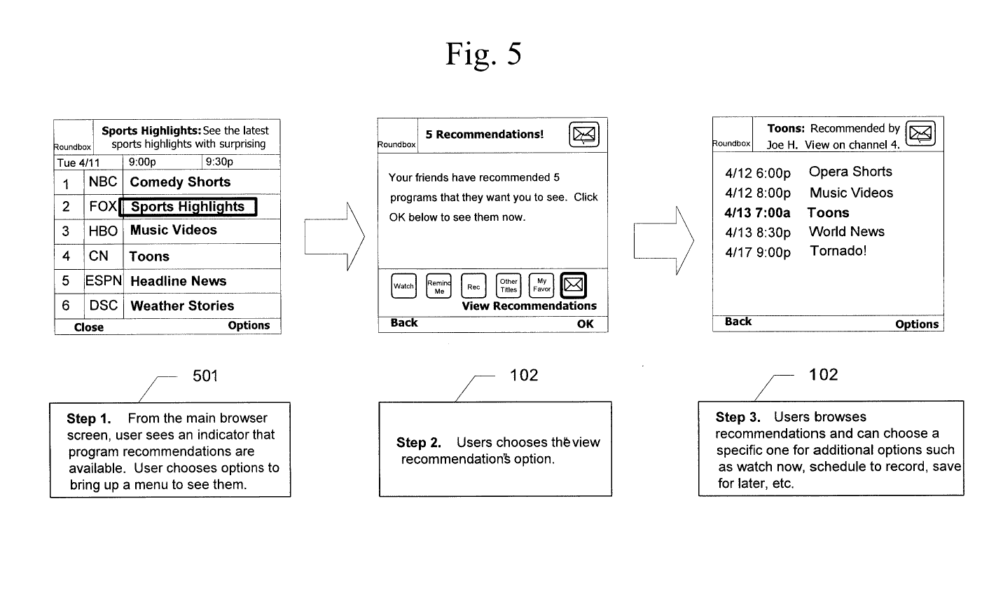

FIG. 5 shows how users may view recommendations they have received. In step 501, while browsing content, an icon may appear on the screen that indicates that program recommendations are available. In step 502, the user can choose the options menu, select view recommendations, and browse all recommendations that are available. In step 503, while browsing the recommendations, options such as view program now, record program, set a reminder, remove from list, and others can be made available when appropriate.

Content Provider Content Recommendation Module

The in-network content recommendation module receives and sends content recommendations for all devices served by the network in which it resides. It may have access to ESG data for all content that can be served to devices on the network. If different users on the network access some content at different times, or via different means, the ESG data will contain these distinctions. For example, users in different parts of the country may access a particular broadcast television program at different local times. If the ESG data is not available locally to the content recommendation module, it will use the services of the content recommendation server when handling recommendations between two users on the same network.

For recommendations initiated by a user on the network destined for users outside the network, the content recommendation module will forward such recommendations to the content recommendation server. The content recommendation server will handle any content access time and method conversions, and forward the updated recommendation to the intended recipient.

Global Content Identifier

Each piece of content that can be viewed, listened to, or otherwise used on a client device must have a unique identifier that can be used to identify that content. For example, each episode of a weekly television program must have a unique identifier so that one episode can be distinguished from another.

It may be the case where a specific content provider does not identify content it provider to its users using global content identifiers. In such cases, the content recommendation server will need to maintain a mapping table for those content providers. The mapping table will allow the content recommendation server to map between the global content identifier and the identifier used by the content provider.

Content Recommendation Server

The content recommendation server is responsible for providing recommendations across content provider's systems. The content recommendation server is also responsible for maintaining cross-reference data, in the form of databases, tables, or other data structure representations, that specify how and when each piece of content is accessed on each of the content provider's content delivery system. The content recommendation server is also responsible for maintaining subscriber information, in the form of databases, tables, or other data structure representation.

The cross-reference data are built and maintained using information from content providers as well as network service providers. For example, the cross-reference data can be built using ESG data for each content provider. The content recommendation server would need enough common information to map entries from one content provider's ESG data to another content provider's ESG data. This could be accomplished by requiring that content provider ESG data contain a globally unique content identifier that matches across content provider's ESG data. Alternatively, information from content providers can be combined with each content provider's ESG data to map the content across content providers.

The subscriber information may comprise but not limited to subscriber identification, location of the subscriber, identification of the network service provider to which the user's client device is connected, user's client device's communication capability, user's client device's display capability. Information in the subscriber information database 124 may be supplied by the network service providers. Users can also supply information to the subscriber information database through online registration.

When a recommendation comes in from a content provider system or client device, the recommendation server, using the cross-reference data for the originating and destination content providers, lookup content access information for the recommended content on the destination content provider and forwards that updated recommendation information to the destination content provider system for eventual delivery to the targeted user.

It is possible that there are multiple program information instances that match a recommendation in the recipient's content provider. For benefits of the recipient, the multiple matching could be filtered using any filtering strategy. Some examples of filtering strategies, but not limited to, are as following:
1. Filter by time—show only programs in the certain time period.
2. Filter by subscriber information—show only programs that the recipient has subscription to. Program content may be available at multiple channels which the recipient has access to only a subset of them.
3. Filter by the recipient's client device characteristics—show only programs that the recipient's client device is capable to access or display.
4. Filter by the recipient's location—show only programs that is available in the recipient's location.
5. Return only the first few numbers of the instances based on program show time.

The filtering function can be performed at the Content Recommendation Server, recipient's Recommendation Module, or recipient's client device.

Alternative Recommendation Flows

It may be the case where content recommendations are sent directly from one device to another. This might be accomplished via a mechanism such as SMS. In such cases, the recommendation server is bypassed. In order to ensure that the recommended content is shown to the recipient using the correct time and access method, the recipient's device must get that information from the content recommendation server. It may be the case where that information is not obtained until the recipient explicitly asks for it. For example, the recommendation itself may contain enough information to generally describe the content being recommended (i.e., television program name, music video name). If the recipient expresses interest in viewing the recommendation, the detailed time and access method could be obtained from the recommendation server at that time.

In order for the recipient to obtain the local access time and method for the recommended content, enough information must be present in the recommendation for the recommendation server to look up the correct information for the recipient. This would include, at a minimum, either a global content identifier, or an identifier for the content provider of the user who made the recommendation, as well as a content identifier specific to that content provider or network service provider.

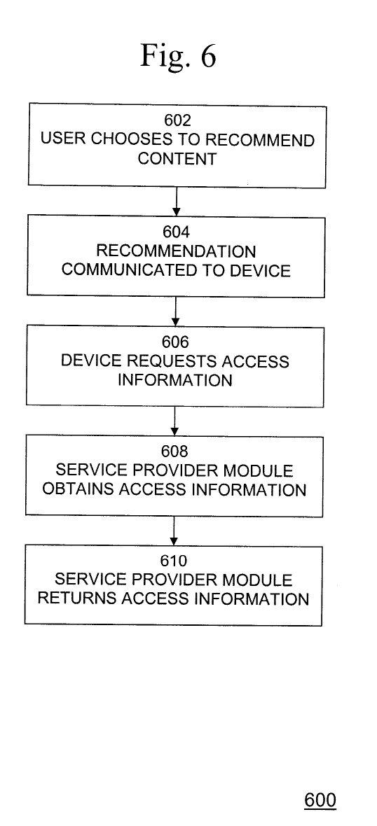

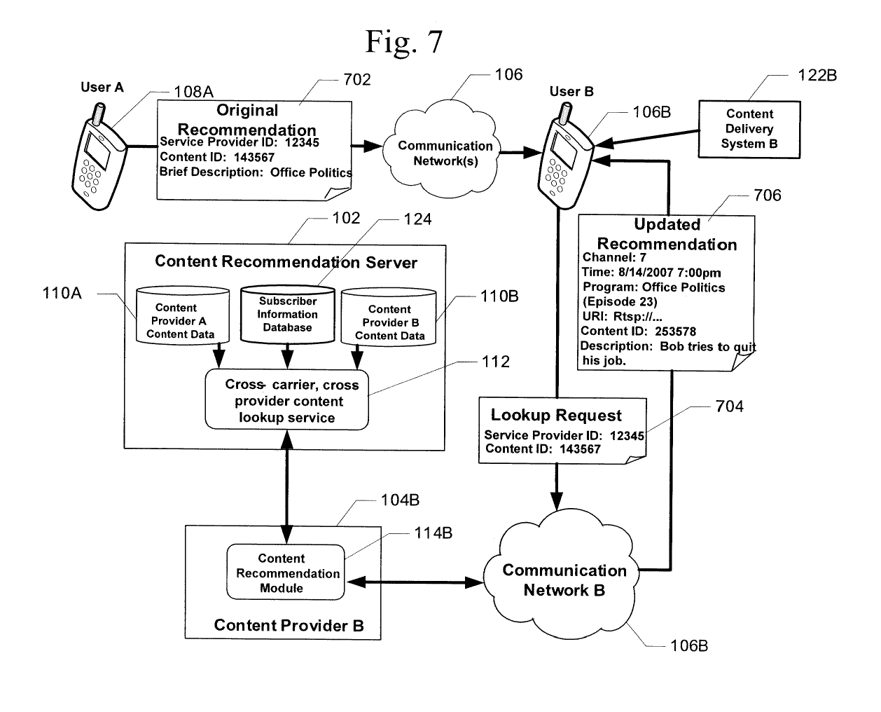

FIG. 6 illustrates an example of a process 600 followed to recommend content using the alternative recommendation flow. It is best viewed in conjunction with FIG. 7, which shows the data flow during process 600. In step 602, user A using device 108A chooses to recommend content to user B. In step 604, the recommendation 702 is communicated directly to user B's device 108B, bypassing the content provider recommendation module 114A and the recommendation server 102, via SMS or other communication method. In step 606, user B's device 108B requests 704 information on how to access the recommended content, supplying information contained within the recommendation, to user B's content provider's content recommendation module. Request 704 can occur immediately when the recommendation is received, or can occur when the user chooses to view the recommendation's details.

In step 608, user B's content provider's content recommendation module 114B obtains the content's updated recommendation information 706 from the recommendation server 102. In step 610, user B's content provider's content recommendation module 114B returns the updated recommendation information 706 to user B's device 108B. Depending on the nature of the application, the updated recommendation may be displayed to the user immediately, or at a later time. The user and/or application may use the access information in the updated recommendation to view, download, or record the content at appropriate time, making use of the content delivery system 122B.

It may also be the case where the updated content recommendation information for User B is sent directly from one device to another. This might be accomplished via a mechanism such as SMS. This is useful if User B does not have access to content provider B's Content Recommendation Module or content provider B does not provide the service of Content Recommendation Module. It is also possible that content provider B does not provide the recommended program. In such cases, the program list of content provider B does not contain the recommended program. However, the recommendation information for User B may contain other access information such off the air, Internet URI etc. In order to ensure that the information about the recommended content for User B is available, User A's device can request the information about the recommended program from the Content Recommendation Module provided by content provider A using the local content ID, and the network service provider B's and/or the content provider B's identification. The Content Recommendation Module will then obtain the program information from the Content Recommendation Server. The Content Recommendation Server can look up the program information for User B using the local content ID which can be mapped to the Global Content Identifier. Together with the Global Content Identifier and network service provider B's and/or the content provider B's identification, program information details for User B can be retrieved. The updated recommendation information is returned to User A's device. User A's device then sends the updated recommendation details directly to User B's device. This might be accomplished via a mechanism such as SMS.

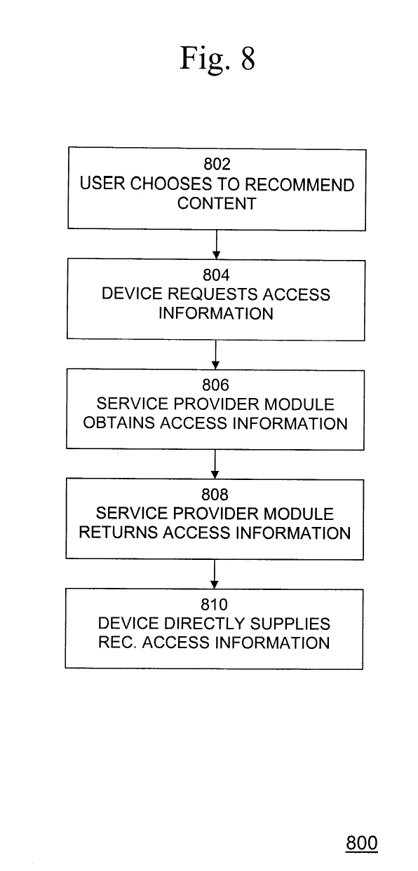

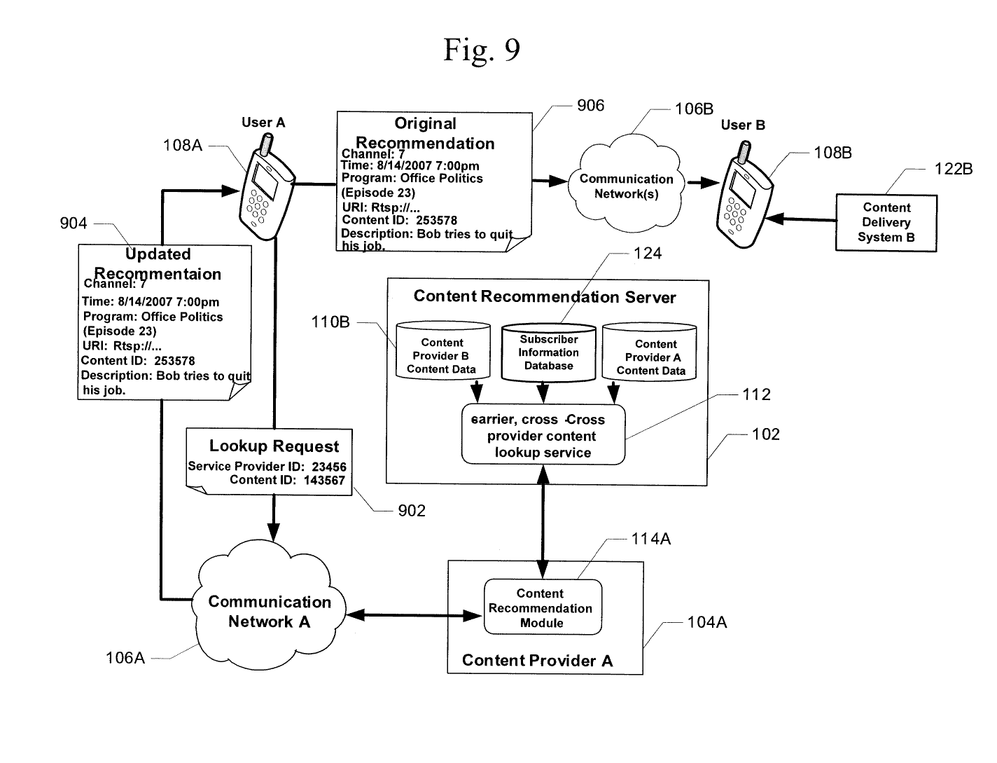

FIG. 8 illustrates an example of a process 800 to recommend content using the alternative recommendation flow. It is best viewed in conjunction with FIG. 9, which shows the data flow during process 800. In step 802, user A chooses to recommend content to user B. In step 804, user A's device 108A requests 902 information on how to access the recommended content, supplying information about the recommendation, to user A's content provider's content recommendation module 114A. In step 806, user A's content provider's content recommendation module 114A obtains the updated recommendation information 904 from the recommendation server 102 for User B. In step 808, user A's content provider's content recommendation module 114A returns the updated recommendation information 904 to user A's device 108A. In step 810, user A's device 108A communicates directly to User B's device 108B, via SMS or other communication method, supplying the updated recommendation information 904 for User B. Depending on the nature of the application, the updated recommendation may be displayed to the user immediately, or at a later time. The user and/or application may use the access information in the updated recommendation to view, download, or record the content at appropriate time, making use of the content delivery system 122B.

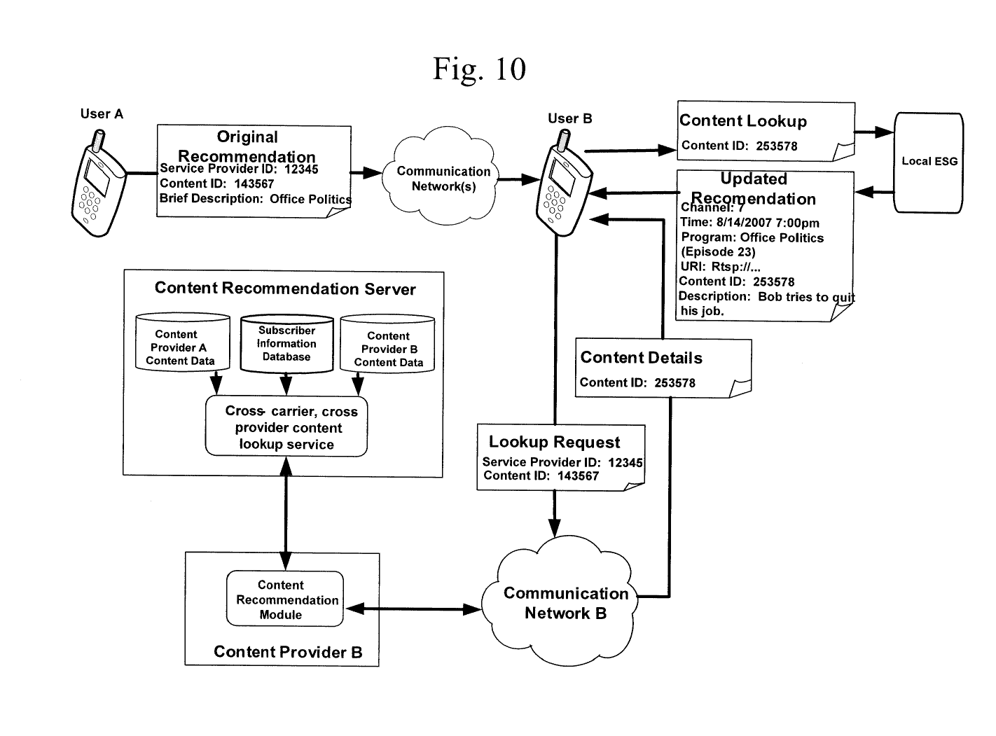

Another variation of a preferred implementation is that the program access information can be maintained by another third-party ESG provider. The access information is indexed by the local content ID. The Content Recommendation Server will perform the cross reference function to retrieve the recipient's local content ID using the sender's local content ID. The retrieval of the recipient's local content ID can use any one of the flow as described above. The recipient's device will then use the local content ID to retrieve the access information from the local ESG. FIG. 10 shows the implementation of this variation using one of the above-described recommendation flows.

Significant advantages provided by the present invention include:
The content recommended is shown to the recipient using the recipient's content access time and method, which is not necessarily the same as the content access time and method of the user making the recommendation.
The content recommendation server aggregates and maintains content details (program descriptions, access methods, access times) for all network service providers and content providers supported by the system.
The content recommendation feature can be fully integrated with the ESG running on all client devices to allow for seamless and easy recommendation management by users of the ESG.
The content recommendation server aggregates and maintains content access details (URLS, Content IDs) for all on-demand content providers supported by the system.
The content recommendation server provides a cross reference service of content details for all content providers. Content details for target content provider can be retrieved using local content ID and the identification of the target content provider.

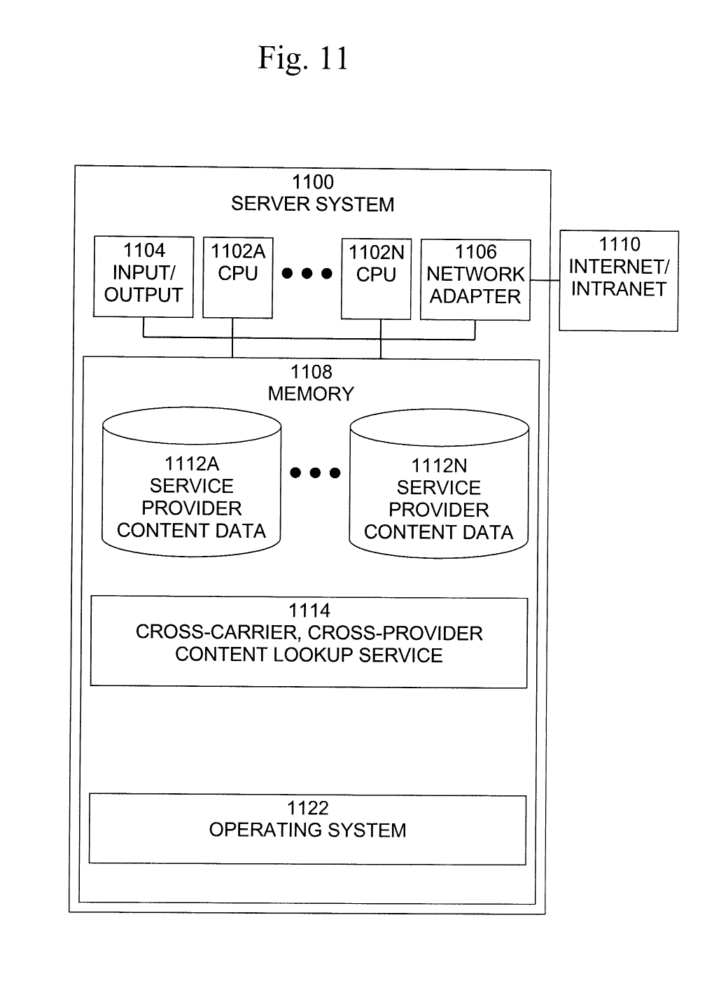

An exemplary block diagram of a server computer system 1100, such as a content recommendation server or a server on which the content recommendation module executes, shown in FIG. 1, is shown in FIG. 11. Server 1100 is typically a programmed general-purpose computer system, such as a personal computer, workstation, server system, and minicomputer or mainframe computer. Server 1100 includes one or more processors (CPUs) 1102A-1102N, input/output circuitry 1104, network adapter 1106, and memory 1108. CPUs 1102A-1102N execute program instructions in order to carry out the functions of the present invention. Typically, CPUs 1102A-1102N are one or more microprocessors, such as an INTEL PENTIUM® processor. FIG. 11 illustrates an embodiment in which Server 1100 is implemented as a single multi-processor computer system, in which multiple processors 1102A-1102N share system resources, such as memory 1108, input/output circuitry 1104, and network adapter 1106. However, the present invention also contemplates embodiments in which server 1100 is implemented as a plurality of networked computer systems, which may be single-processor computer systems, multi-processor computer systems, or a mix thereof.

Input/output circuitry 1104 provides the capability to input data to, or output data from, database/server 1100. For example, input/output circuitry may include input devices, such as keyboards, mice, touchpads, trackballs, scanners, etc., output devices, such as video adapters, monitors, printers, etc., and input/output devices, such as, modems, etc. Bearer network adapter 1106 interfaces device 1100 with a plurality of bearer networks 1110A-N. Bearer networks 1110A-N may be any standard bearer network or WLAN, such as GSM, GPRS, EVDO, WiMAX, LTE, Wi-Fi, CDMA, etc., or a private or proprietary bearer network.

Memory 1108 stores program instructions that are executed by, and data that are used and processed by, CPU 1102 to perform the functions of server 1100. Memory 1108 may include electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

The contents of memory 1108 varies depending upon the function that server 1100 is programmed to perform. In the example shown in FIG. 11, memory 1108 includes content provider content data 1112A-N, cross-carrier, cross-provider content lookup service 1114, and operating system 1120. Content provider content data 1112A-N include information relating to content and programming information for each content provider, including how to access the content for each network and content provider's delivery system. Cross-carrier, cross-provider content lookup service 1114 provides the capability to receive requests for information from client devices and content provider networks, to lookup and access information relating to particular content in content provider content data 1112A-N, and to provide the access information in response to the requests. Operating system 1120 provides overall system functionality.

As shown in FIG. 11, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

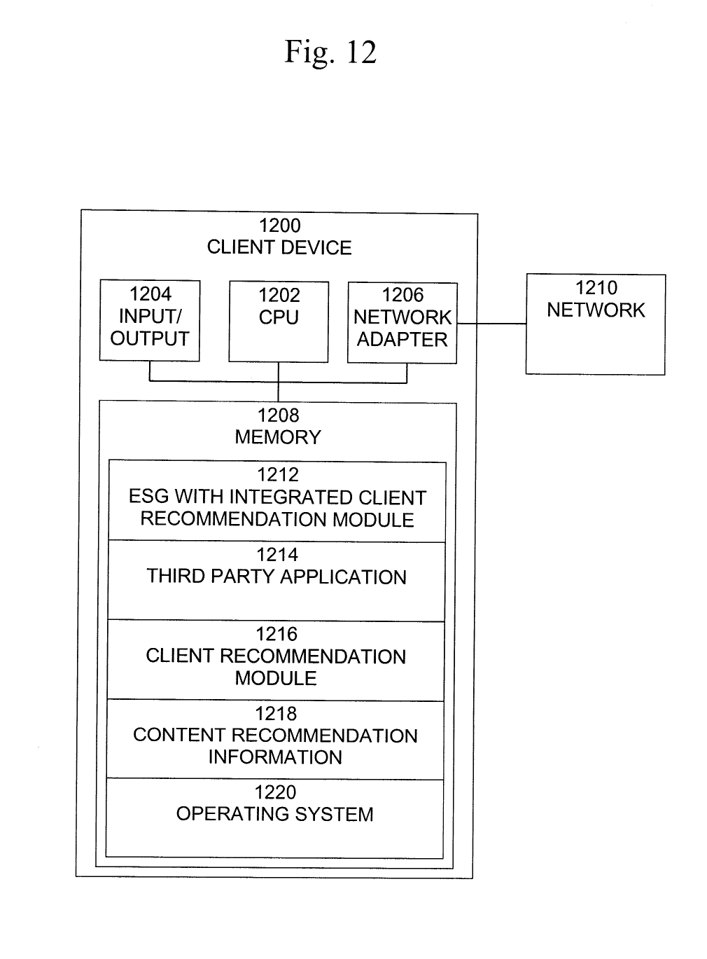

An exemplary block diagram of a client device 1200 in which the present invention may be implemented is shown in FIG. 12. Device 1200 is typically a wireless communication and/or computation device, such as a mobile phone, personal digital assistant, personal computer, and the like. Device 1200 includes processor (CPU) 1202, input/output circuitry 1204, network adapter 1206, memory 1208, and mass storage 1210. CPU 1202 executes program instructions in order to carry out the functions of the present invention. Typically, CPU 1202 is an embedded microprocessor, but may also be a microcomputer or other embedded processing device. Although in the example shown in FIG. 12, device 1200 is a single processor system, the present invention contemplates implementation on a system or systems that provide multi-processor, multi-tasking, multi-process, multi-thread computing, distributed computing, and/or networked computing, as well as implementation on systems that provide only single processor, single thread computing. Likewise, the present invention also contemplates embodiments that utilize a distributed implementation, in which device 1200 is implemented on a plurality of networked computer systems, which may be single-processor computer systems, multi-processor computer systems, or a mix thereof.

Input/output circuitry 1204 provides the capability to input data to, or output data from, device 1200. For example, input/output circuitry may include input devices, such as keyboards, mice, touchpads, trackballs, scanners, etc., output devices, such as video adapters, monitors, printers, etc., and input/output devices, such as, modems, etc. Bearer network adapter 1206 interfaces device 1200 with a plurality of bearer networks 1211A-N. Bearer networks 1211A-N may be any standard bearer network or WLAN, such as MediaFLO™, DVB-H, DMB, MBMS, BCMCS, GSM, GPRS, EVDO, WiMAX, LTE, Wi-Fi, CDMA, etc., or a private or proprietary bearer network.

Memory 1208 stores program instructions that are executed by, and data that are used and processed by, CPU 1202 to perform the functions of the present invention. Memory 1208 may include volatile memory, including electronic memory devices such as random-access memory (RAM), and non-volatile memory, including electronic memory devices such as read-only memory (ROM), programmable read-only memory (PROM), electrically erasable programmable read-only memory (EEPROM), flash memory, etc. Memory 1208 may also include mass storage that provides the capability to store large amounts of information, such as program instructions and data, in a persistent and accessible form. Mass storage typically includes electro-mechanical storage devices, such as magnetic disk drives, tape drives, optical disk drives, etc., which may use an integrated drive electronics (IDE) interface, or a variation or enhancement thereof, such as enhanced IDE (EIDE) ultra direct memory access (UDMA), or Serial Advanced Technology Attachment (SATA), or a small computer system interface (SCSI) based interface, or a variation or enhancement thereof, such as fast-SCSI, wide-SCSI, fast and wide-SCSI, etc, or a fiber channel-arbitrated loop (FC-AL), etc. Mass storage may also include electronic memory devices, which are typically non-volatile devices, such as those described above, but which also may be volatile memory devices.

Memory 1208 may include ESG with integrated client recommendation module 1212, third-party application 1214, client recommendation module 1216, content recommendation information 1218, and operating system 1220. Client recommendation module 1216 provides the capability to recommend content to other users, provides a common application interface forward content recommendations, and receives content recommendation information 1218 from users on the same network service provider network and users on other network service provider networks. Third-party application 1214 receives content recommendation information 1218 from client recommendation module 1216 and displays or otherwise provides them to the user of the device. ESG with integrated client recommendation module 1212 combines the functions of client recommendation module 1216 with the capability to display received content recommendation information 1218 along with the display of ESG information. Operating system 1222 provides overall system functionality.

Additional features and functions provided by the present invention may include:
The content recommended is shown to the recipient using the recipient's content access time and method, which is not necessarily the same as the content access time and method of the user making the recommendation.
The content recommendation server aggregates and maintains content details (program descriptions, access methods, access times) for all network service providers and content providers supported by the system.
The content recommendation feature can be fully integrated with the ESG running on all client devices to allow for seamless and easy recommendation management by users of the ESG.
The content recommendation server aggregates and maintains content access details (URLS, Content IDs) for all on-demand network service providers and content providers supported by the system.
The content recommendation server provides a cross reference service of content details for all network service providers and content providers. Content details for target client device can be retrieved using local content ID and the identification of the target network service provider and/or the target content provider.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include storage media, examples of which include, but are not limited to, floppy disks, hard disk drives, CD-ROMs, DVDROMs, RAM, and, flash memory, as well as transmission media, examples of which include, but are not limited to, digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for providing a content recommendation comprising:
receiving an original recommendation for content, the content recommendation originating from a first client device communicating using a first communication network and destined for a second client device using the same or second communication network;
determining access information for the second client device to access the content; and
providing an updated content recommendation containing the determined access information for the second client device.

2. The method of claim 1, wherein the content is accessible in at least one of the following formats: broadcasted content, simulcast content, file based content, or on-demand streaming content.

3. The method of claim 1, wherein the access information comprises at least one of a description of the content, at least one method to use to access the content, and at least one time at which to access the content.

4. The method of claim 1, wherein the original content recommendation is received from the first client device via the first communication network directly or via a first content provider system after the first content provider system determines that the second client device communicates using a communication network other than the first communication network.

5. The method of claim 1, wherein the original content recommendation is received from the second client device via the second communication network directly or via the second content provider system after the second client device receives the original content recommendation from the first client device.

6. The method of claim 1, wherein the updated content recommendation is provided to the first client device via the first communication network directly or via the first content provider system before the first client device transmits the updated content recommendation to the second client device.

7. The method of claim 1, wherein the updated content recommendation is provided to the second client device via the second communication network directly or via the second content provider system.

8. The method of claim 1, wherein determination of the access information in the updated recommendation comprises a cross reference of information relating to the plurality of content on the plurality of network service provider networks and content provider system, and subscriber information.

9. The method of claim 8, wherein the access information comprises at least one of a description of the content, at least one method to use to access the content, and at least one time at which to access the content.

10. The method of claim 9, wherein the updated recommendation is optionally filtered by one or plurality of recipient's subscribing information, recipient's location, recipient's client device receiving and display capabilities

11. A content recommendation server system for providing content recommendations comprising:
a processor to execute computer program instructions;
a memory to store:
access information for a plurality of content on a plurality of content provider delivery systems;
a subscriber information database; and
computer program instructions executable by the processor to perform the steps of:
receiving an original recommendation for content, the content recommendation originating from a first client device communicating using a first communication network and destined for a second client device using the same or a second communication network;
determining access information for the second client device to access the content; and
providing an updated content recommendation containing the determined access information for the second client device.

12. The system of claim 11, wherein the subscriber information database comprises a subscriber identity, a subscriber's location, a subscriber's client device's receiving and displaying capability, and a network service provider identifier.

13. The system of claim 11, wherein the subscriber information is provided by the content providers, and/or provided by the client via a registration mechanism.

14. The system of claim 11, wherein the content may be accessible in one or more of the following formats: broadcasted content, simulcast content, file based content, or on-demand streaming content.

15. The system of claim 11, wherein the access information comprises at least one of a description of the content, at least one method to use to access the content, and at least one time at which to access the content.

16. The system of claim 11, wherein the original content recommendation is received from the first client device via the first communication network directly or via a first content provider system after the first content provider system determines that the second client device communicates using a communication network other than the first communication network.

17. The system of claim 11, wherein the original content recommendation is received from the second client device via the second communication network directly or via the second content provider system after the second client device receives the original content recommendation from the first client device.

18. The system of claim 11, wherein the updated content recommendation is provided to the first client device via the first communication network directly or via the first content provider system before the first client device transmits the updated content recommendation to the second client device.

19. The system of claim 11, wherein the updated content recommendation is provided to the second client device via the second communication network directly or via the second content provider system.

20. The system of claim 11, wherein determination of the access information in the updated recommendation comprises a cross reference of information relating to the plurality of content on the plurality of network service provider networks and content provider system, and subscriber information.

21. The system of claim 20, wherein the access information comprises at least one of a description of the content, at least one method to use to access the content, and at least one time at which to access the content.

22. The system of claim 21, wherein the updated recommendation is filtered by one or plurality of recipient's subscribing information, recipient's location, recipient's client device receiving and display capabilities

23. A client device for providing content recommendations to a user of the client device comprising:
a processor to execute computer program instructions;
communication circuitry to communicate information using a network service provider network; and
a memory to store computer program instructions executable by the processor to perform functions, comprising:
originating an original recommendation upon a user's request,
receiving an original recommendation for content via a communication network,
receiving an updated recommendation for content via a communication network,
sending an original recommendation to a content provider system via a communication network,
sending an original recommendation to a content recommendation server via a communication network,
sending an original recommendation to a second client device via a communication network,
sending an updated recommendation to a second client device via a communication network,
notifying the user of the client device that a content recommendation is available,
filtering the updated recommendation by one or plurality of recipient's subscribing information, recipient's location, recipient's client device receiving and display capabilities,
displaying the received content recommendation to the user,
acquiring the content using access information in updated recommendation from a content delivery system, upon user's request,
rendering or otherwise processing the acquired content upon user's request.

24. The device of claim 23, wherein computer program further performs the following steps:
originating an original recommendation upon user's request,
sending an original recommendation to one of the following: a second client device, a content provider system, or a content recommendation server via a communication network.

25. The device of claim 23, wherein computer program further performs the following steps:
originating an original recommendation upon user's request,
sending an original recommendation to a content provider system or a content recommendation server via a communication network,
receiving an updated recommendation for content via a communication network,
sending an updated recommendation to a second client device via a communication network.

26. The device of claim 23, wherein computer program performs the following steps:
receiving an original recommendation for content via a communication network,
sending an original recommendation to a content provider system or content recommendation server via a communication network,
receiving an updated recommendation for content via a communication network,
notifying the user of the client device that a content recommendation is available,
optionally filtering the updated recommendation by one or plurality of recipient's subscribing information, recipient's location, recipient's client device receiving and display capabilities
displaying the received content recommendation to the user,
acquiring the content using access information in updated recommendation from a content delivery system, upon user's request,
rendering or otherwise processing the acquired content upon user's request.

27. The device of claim 23, wherein computer program performs the following steps:
receiving an updated recommendation for content via a communication network,
notifying the user of the client device that a content recommendation is available,
optionally filtering the updated recommendation by one or plurality of recipient's subscribing information, recipient's location, recipient's client device receiving and display capabilities,
displaying the received content recommendation to the user,
acquiring the content using access information in updated recommendation from a content delivery system, upon user's request,
rendering or otherwise processing the acquired content upon user's request.

28. The device of claim 23, wherein the device has a memory to store the access information for a plurality of content on a plurality of content provider delivery systems, the computer program performs the following steps:
receiving an original content recommendation from another client device,
determining the updated recommendation using the method as described in claim 8 and the locally access information,
notifying the user of the client device that a content recommendation is available,
optionally filtering the updated recommendation by one or plurality of recipient's subscribing information, recipient's location, recipient's client device receiving and display capabilities,
displaying the received content recommendation to the user,
acquiring the content using access information in updated recommendation from a content delivery system, upon user's request,
rendering or otherwise processing the acquired content upon user's request.

29. A computer program product for providing content recommendation service comprising:
a computer readable storage medium;
computer program instructions, recorded on the computer readable medium, executable by a processor on a server or on a client device, for performing the steps of:
receiving an original recommendation for content, the content recommendation originating from a first client device communicating using a first communication network and destined for a second client device using the same or second communication network;
determining access information for the second client device to access the content; and
providing an updated content recommendation containing the determined access information for the second client device.

30. The computer program product of claim 29, wherein the original content recommendation is received from the first client device via the first communication network directly or via a first content provider system after the first content provider system determines that the second client device communicates using a communication network other than the first communication network.

31. The computer program product of claim 29, wherein the original content recommendation is received from the second client device via the second communication network directly or via the second content provider system after the second client device receives the original content recommendation from the first client device.

32. The computer program product of claim 29, wherein the updated content recommendation is provided to the first client device via the first communication network directly or via the first content provider system before the first client device transmits the updated content recommendation to the second client device.

33. The computer program product of claim 29, wherein the updated content recommendation is provided to the second client device via the second communication network directly or via the second content provider system.

34. The computer program product of claim 29, wherein determination of the access information in the updated recommendation comprises a cross reference of information relating to the plurality of content on the plurality of network service provider networks and content provider system, and subscriber information.

35. The computer program product of claim 34, wherein the access information comprises at least one of a description of the content, at least one method to use to access the content, and at least one time at which to access the content.
